(19) United States
(12) Patent Application Publication
(10) Pub. No.: US 2016/0070450 A1
(43) Pub. Date: Mar. 10, 2016

(54) ELECTRONIC DEVICE, METHOD, AND COMPUTER PROGRAM PRODUCT

(71) Applicant: KABUSHIKI KAISHA TOSHIBA, Tokyo (JP)

(72) Inventors: Yuuji IRIMOTO, Fussa Tokyo (JP); Daisuke HIRAKAWA, Saitama Saitama (JP); Takako SUZUKI, Nerima Tokyo (JP)

(21) Appl. No.: 14/733,587

(22) Filed: Jun. 8, 2015

(30) Foreign Application Priority Data
Sep. 8, 2014 (JP) 2014-182397

(51) Int. Cl. G06F 3/0484; G06T 11/60; G06F 3/0486

(52) U.S. Cl. CPC G06F 3/04845; G06F 3/0486; G06T 11/60; G06T 2200/24

(57) ABSTRACT

An electronic device includes: circuitry configured to cause a first object and a first operator to be displayed on a display area of a display, the first operator used for issuing an instruction to execute a process comprising at least one of a movement, an enlargement, or a reduction of the first object, the first operator positioned at a first position determined according to an edge position of the first object, the circuitry being configured to display the first operator at a second position when the second position of the first operator determined according to an edge position of the first object is inside of the display area after at least one of a movement, an enlargement, or a reduction of the first object, the circuitry being configured to display the first operator at a fourth position different from a third position when the third position of the first operator determined according to a third edge position of the first object is outside of the display area after at least one of a movement, an enlargement, or a reduction of the first object.

### CROSS-REFERENCE TO RELATED APPLICATIONS

This application is based upon and claims the benefit of priority from Japanese Patent Application No. 2014-182397, filed Sep. 8, 2014, the entire contents of which are incorporated herein by reference.

### FIELD

Embodiments described herein relate generally to an electronic device, a method, and a computer program product.

### BACKGROUND

There are applications such as an image collage application and a presentation application that can freely execute processing such as arrangement, movement, enlargement, reduction, and rotation of an object displayed on a display screen of a display module.

In the above applications, by use of an object such as a user interface (UI) arranged at the end of an object, the execution of processing on the object can be instructed. However, when the UI moves out of the display screen by a change of the size of the object or the like, in order to instruct the execution of processing on the object by use of the UI, it is necessary to once move the object to the inside of the display screen and instruct the execution of processing on the object by use of the UI.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram illustrating an example of the appearance of a tablet terminal according to a first embodiment;

FIG. 2 is an exemplary diagram illustrating an example of the hardware configuration of the tablet terminal in the first embodiment;

FIG. 3 is an exemplary flowchart illustrating the procedure of image editing processing by the tablet terminal in the first embodiment;

FIG. 4 is an exemplary diagram illustrating an example of a frame selection screen displayed by the tablet terminal in the first embodiment;

FIGS. 5A and 5B are exemplary diagrams illustrating an example of an image selection screen displayed by the tablet terminal in the first embodiment;

FIG. 6 is an exemplary diagram illustrating an example of an editing screen displayed by the tablet terminal in the first embodiment;

FIGS. 7A and 7B are exemplary diagrams illustrating an example of an image editing screen displayed by the tablet terminal in the first embodiment;

FIG. 8 is an exemplary diagram illustrating an example of movement processing on operators by the tablet terminal in the first embodiment;

FIGS. 9A and 9B are exemplary diagrams illustrating an example of a stamp selection screen displayed by the tablet terminal in the first embodiment;

FIGS. 10A and 10B are exemplary diagrams illustrating an example of a text editing screen displayed by the tablet terminal in the first embodiment;

FIG. 11 is an exemplary diagram illustrating an example of a background selection screen displayed by the tablet terminal in the first embodiment;

FIGS. 12A to 12F are exemplary diagrams illustrating an example of a layout change screen displayed by the tablet terminal in the first embodiment;

FIG. 13 is an exemplary diagram illustrating an example of a saving screen displayed by the tablet terminal in the first embodiment;

FIG. 14 is an exemplary diagram for explaining an example of a method for displaying operators by a tablet terminal according to a second embodiment;

FIG. 15 is an exemplary diagram for explaining an example of the method for displaying operators by the tablet terminal in the second embodiment;

FIG. 16 is an exemplary diagram for explaining an example of the method for displaying operators by the tablet terminal in the second embodiment;

FIG. 17 is an exemplary diagram for explaining an example of the method for displaying operators by the tablet terminal in the second embodiment; and

FIG. 18 is an exemplary diagram for explaining an example of the method for displaying operators by the tablet terminal in the second embodiment.

### DETAILED DESCRIPTION

In general, according to one embodiment, an electronic device comprises: circuitry configured to cause a first object and a first operator to be displayed on a display area of a display, the first operator used for issuing an instruction to execute a process comprising at least one of a movement, an enlargement, or a reduction of the first object, the first operator positioned at a first position determined according to an edge position of the first object, the circuitry being configured to display the first operator at a second position when the second position of the first operator determined according to an edge position of the first object is inside of the display area after at least one of a movement, an enlargement, or a reduction of the first object, the circuitry being configured to display the first operator at a fourth position different from a third position when the third position of the first operator determined according to a third edge position of the first object is outside of the display area after at least one of a movement, an enlargement, or a reduction of the first object.

The following describes a tablet terminal to which an electronic device, a method, and a computer program product according to embodiments are applied with reference to the accompanying drawings.

### First Embodiment

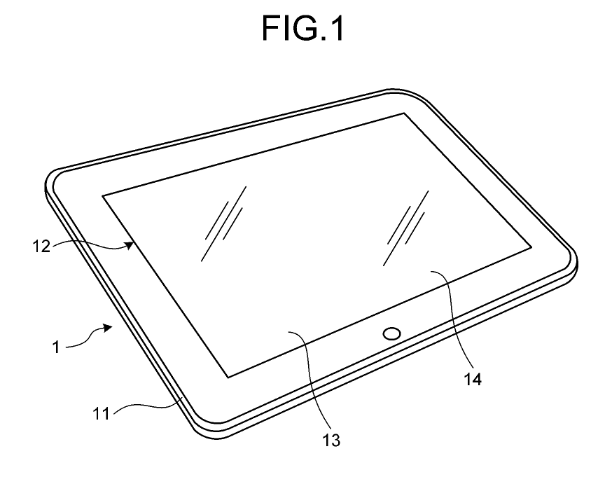

FIG. 1 is a diagram illustrating an example of the appearance of a tablet terminal according to a first embodiment. As illustrated in FIG. 1, this tablet terminal 1 according to the present embodiment comprises a main body 11 and a display module 12. The main body 11 has a thin box-shaped casing. The display module 12 (an example of a display) is a touch panel display comprising a display screen 13 formed by a liquid crystal display (LCD) or the like and a touch panel 14 that is formed by a capacitance type touch panel, an electromagnetic induction type digitizer, or the like and is formed so that a touch operation (tapping) with a stylus, a finger, or the like on the display screen 13 can be detected.

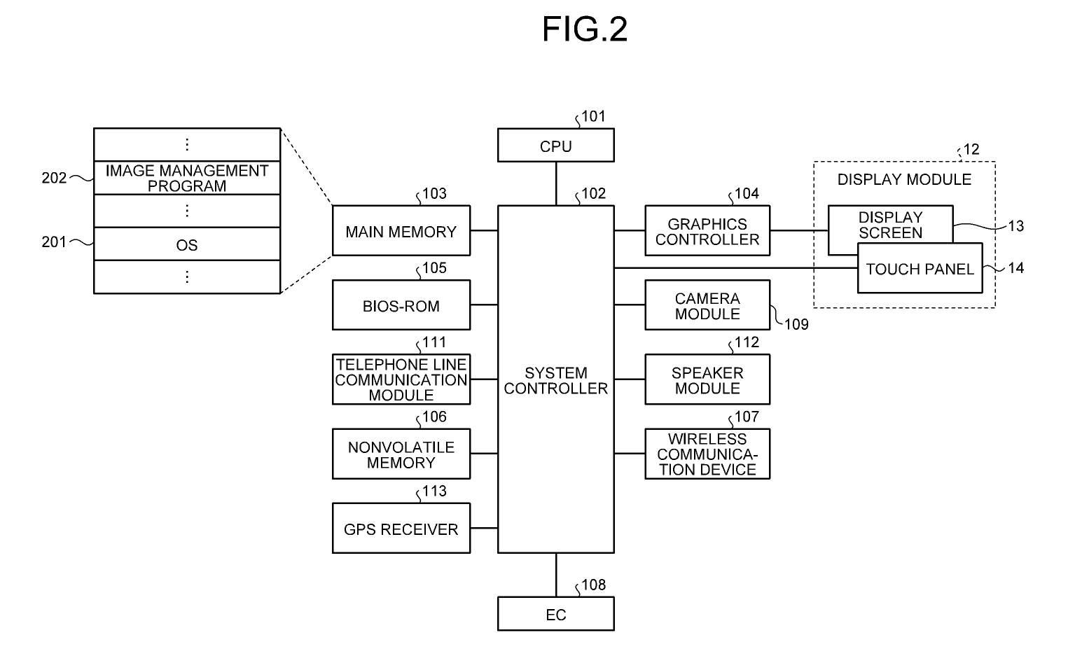

FIG. 2 is a diagram illustrating an example of the hardware configuration of the tablet terminal in the first embodiment. As illustrated in FIG. 2, the tablet terminal 1 according to the present embodiment comprises a central processing unit (CPU) 101, a system controller 102, a main memory 103, a graphics controller 104, a basic input/output (BIOS)-read only memory (ROM) 105, a nonvolatile memory 106, a wireless communication device 107, an embedded controller (EC) 108, a camera module 109, a telephone line communication module 111, a speaker module 112, and a global positioning system (GPS) receiver 113.

The CPU 101 is an example of a processor (computer) that functions as a controller that controls the operation of the various modules of the tablet terminal 1. Specifically, the CPU 101 executes a BIOS stored in the BIOS-ROM 105. The CPU 101 then executes various computer programs loaded from the nonvolatile memory 106 as an example of a storage device onto the main memory 103. Examples of the computer program executed by the CPU 101 may comprise various application programs such as an operating system (OS) 201 and an image management program 202.

The image management program 202 has functionality to execute various processing on image data obtained by image taking by the camera module 109, image data stored in the nonvolatile memory 106, image data stored in an external storage device such as a server, or the like.

The system controller 102 is a device that connects between a local bus of the CPU 101 and the various modules. The system controller 102 has a memory controller that controls access to the main memory 103. The system controller 102 has functionality to communicate with the graphics controller 104 via a PCI Express standard serial bus or the like.

The graphics controller 104 functions as a display controller that controls the display module 12. Specifically, the graphics controller 104, when causing the display module 12 to display a variety of information, generates display signals for displaying the information and outputs the display signals to the display screen 13, thereby causing the display screen 13 to display the information.

The wireless communication device 107 is a device that performs wireless communication with external devices via a wireless local area network (LAN), Bluetooth (registered trademark), or the like. The embedded controller 108 turns on and off the power of the tablet terminal 1.

The camera module 109 functions as an imaging module arranged so as to be able to image the surroundings of the tablet terminal 1 from the face opposite to the face on which the display screen 13 is formed in the main body 11. In the present embodiment, when the touch panel 14 detects that a touch operation on a button displayed on the display screen 13 has been performed by a user, the camera module 109 images the surroundings of the tablet terminal 1. The speaker module 112 outputs sounds such as voices based on sound signals input from the CPU 101 via the system controller 102.

The telephone line communication module 111 is a module for performing data communication with external devices via a base station by use of a mobile communication system such as 3G. The GPS receiver 113 receives the positional information of the tablet terminal 1 measured by a GPS.

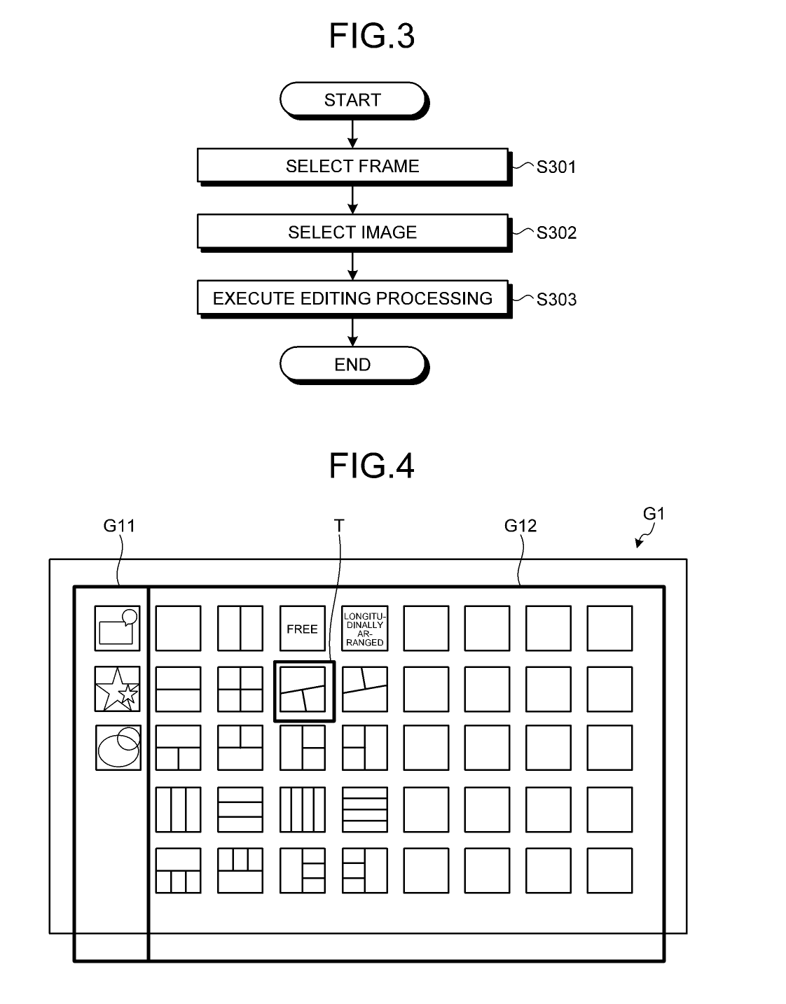

Described next with reference to FIG. 3 is image editing processing by the tablet terminal 1 in the present embodiment. FIG. 3 is a flowchart illustrating the procedure of image editing processing by the tablet terminal in the first embodiment. Although the present embodiment causes the CPU 101 to execute the computer programs (the image management program 202 or the like) stored in the nonvolatile memory 106, thereby performing the image editing processing described below, that is not limiting, and it may be configured that a plurality of processors (the CPU 101 of the tablet terminal 1 and a CPU of an external device, for example) execute the computer programs, thereby performing the image editing processing described below.

In the present embodiment, when a touch operation on a button displayed on the display screen 13 is detected by the touch panel 14, and when editing processing on an image (an image based on the image data obtained by image taking by the camera module 109, an image based on the image data stored in the nonvolatile memory 106 or the external storage device, or the like) is instructed, the CPU 101 causes the display screen 13 to display a frame selection screen for selecting a frame for use in displaying an image. The CPU 101 selects the frame selected by use of the frame selection screen as the frame for use in displaying an image (S301).

FIG. 4 is a diagram illustrating an example of the frame selection screen displayed by the tablet terminal in the first embodiment. As illustrated in FIG. 4, the CPU 101 causes the display screen 13 to display a frame selection screen G1 containing a fixed frame area Gil that arranges a list of frames (hereinafter, each of which is referred to as a fixed frame) in which boundary lines (frames) of image display areas, which are areas arranging images, cannot be moved within a frame and a variable frame area G12 that displays a list of frames (hereinafter, each of which is referred to as a variable frame) in which frames of image display areas can be moved within a frame. The CPU 101 selects a frame on which a touch operation T is detected by the touch panel 14 among the frames arranged in the frame selection screen G1 as the frame for use in displaying an image.

Returning back to FIG. 3, upon selection of the frame for use in displaying an image, the CPU 101 causes the display screen 13 to display an image selection screen for selecting an image to be arranged within the selected frame. The CPU 101 then selects the image selected by use of the image selection screen as an image to be arranged within the frame (S302).

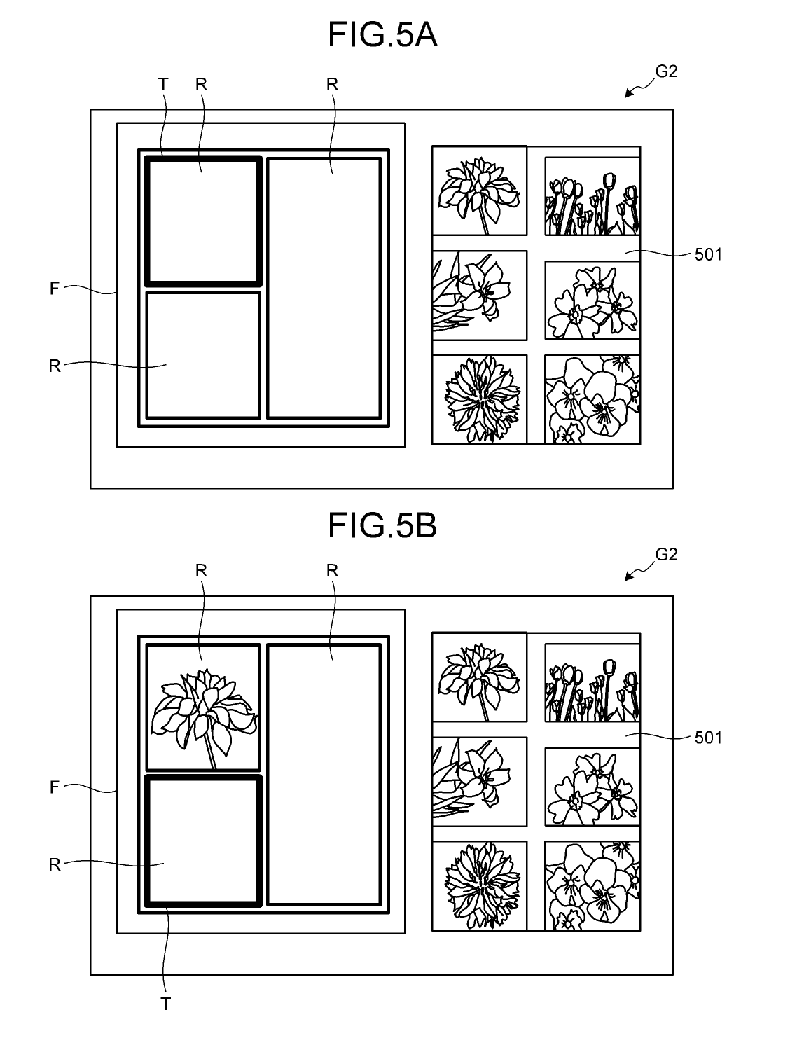

FIGS. 5A and 5B are diagrams illustrating an example of the image selection screen displayed by the tablet terminal in the first embodiment. As illustrated in FIG. 5A, the CPU 101 causes the display screen 13 to display an image selection screen G2 containing a frame F selected by use of the frame selection screen G1 and a list 501 of images that can be arranged in the frame F. The CPU 101 selects an image display area R on which the touch operation T is detected by the touch panel 14 among the image display areas R within the frame F as a selection area for selecting an image to be displayed. As illustrated in FIG. 5B, the CPU 101 then selects an image on which a touch operation is detected by the touch panel 14 among the images arranged in the list 501 of images as an image to be arranged in the selection area. The CPU 101 repeats the selection of images from the list 501 of images until images to be arranged in all the image display areas R within the frame F are selected.

Returning back to FIG. 3, upon selection of the images to be arranged within the frame, the CPU 101 causes the display screen 13 to display an editing screen for instructing the CPU 101 to execute editing processing on the frame that arranges the selected images. The CPU 101 then executes the editing processing instructed by use of the editing screen on the frame that arranges the selected images (S303).

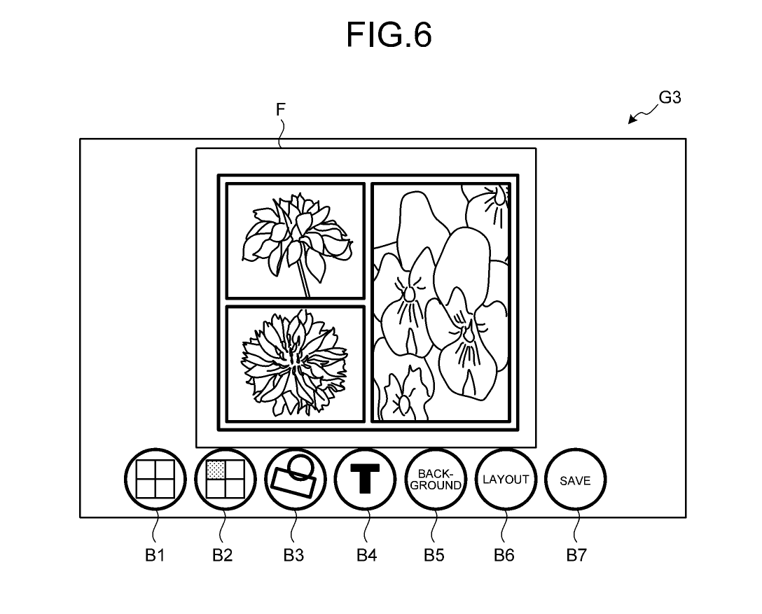

FIG. 6 is a diagram illustrating an example of the editing screen displayed by the tablet terminal in the first embodiment. As illustrated in FIG. 6, the CPU 101 causes the display screen 13 to display an editing screen G3 that arranges the frame F that arranges the selected images, a frame selection button B1 for instructing the CPU 101 to redisplay the frame selection screen G1, an image edit button B2 for instructing the CPU 101 to execute the editing processing on the images arranged in the frame F, a stamp paste button B3 for instructing the CPU 101 to execute stamp pasting processing on the frame F, a text paste button B4 for instructing the CPU 101 to execute text pasting processing on the frame F, a background selection button B5 for instructing the CPU 101 to select background images of the images arranged in the frame F, a layout change instruction button B6 for, when the frame selected by the frame selection screen G1 is a variable frame, instructing the CPU 101 to change the layout of the variable frame, and a save button B7 for instructing the CPU 101 to save the frame F in the nonvolatile memory 106.

When there is no need to discriminate among the frame selection button B1, the image edit button B2, the stamp paste button B3, the text paste button B4, the background selection button B5, the layout change instruction button B6, and the save button B7 below, they are referred to as various buttons B.

Described next is editing processing, when the execution of editing processing on an image arranged in a frame is instructed by use of the image edit button B2, on the image. When the execution of the editing processing on the image is instructed by use of the image edit button B2, the CPU 101 causes the display screen 13 to display an image editing screen for executing the editing processing on the image.

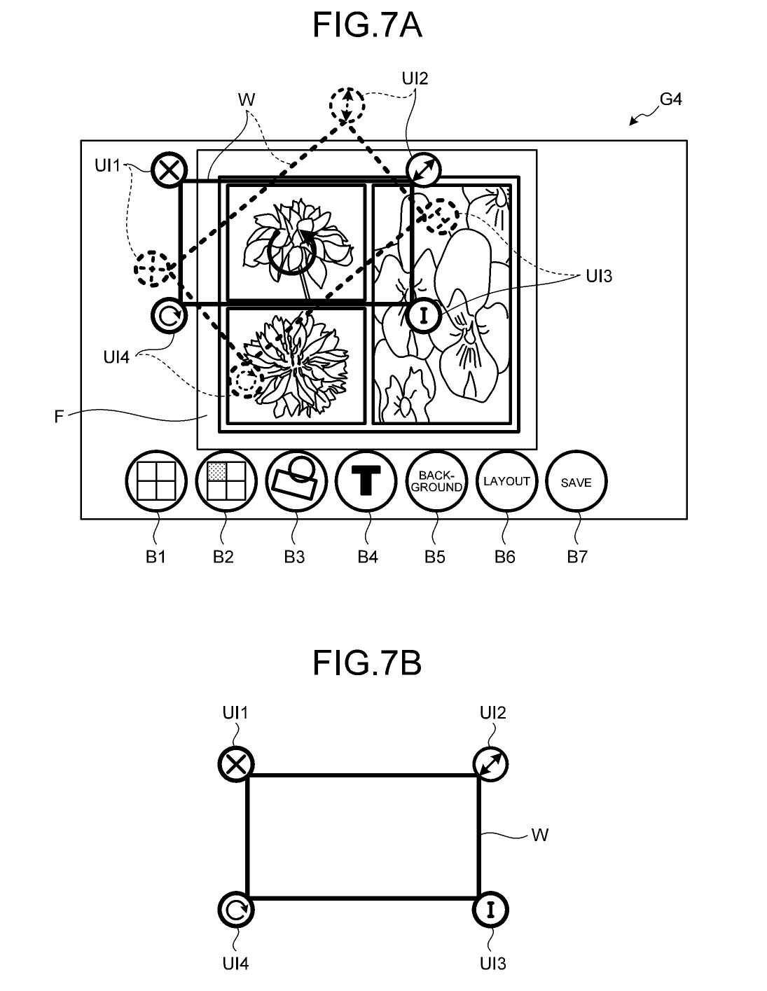

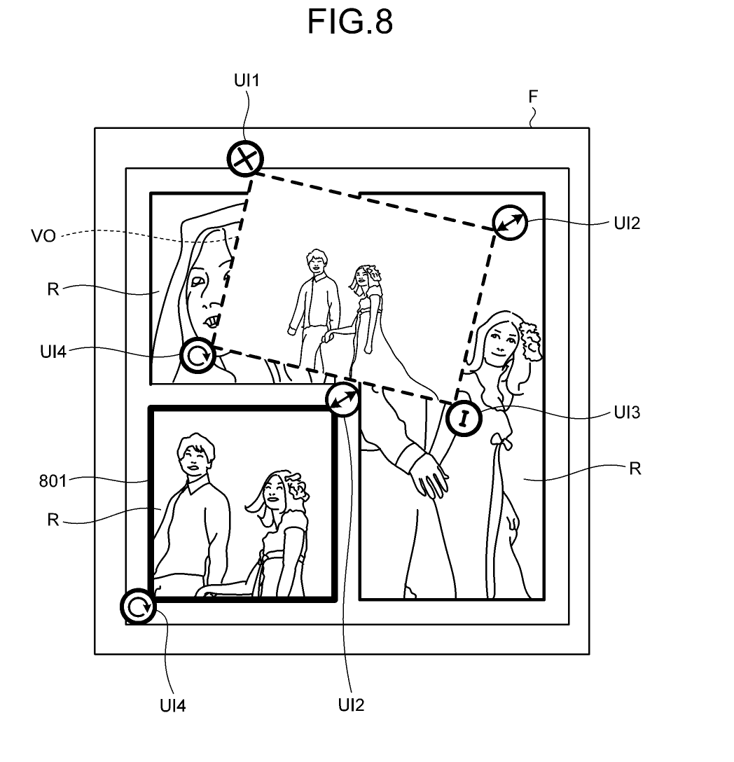

FIGS. 7A and 7B are diagrams illustrating an example of the image editing screen displayed by the tablet terminal in the first embodiment. FIG. 8 is a diagram illustrating an example of movement processing on operators by the tablet terminal in the first embodiment. As illustrated in FIG. 7A, the CPU 101 causes the display screen 13 to display an image editing screen G4 containing the frame F, the various buttons B, and operators UI1, UI2, UI3, and UI4 at a position (a first position) determined based on any position at the end of an image arranged within the frame F for instructing the CPU 101 to execute editing processing (an example of processing) on the image. When there is no need to discriminate among the operators UI1, UI2, UI3, and UI4 below, they are referred to as operators UI.

Although the operators UI are displayed on the image editing screen G4 that contains the image display area within the frame and is larger than the image display area in the present embodiment, that is not limiting so long as the operators UI are displayed on a display area containing the image display area. The same area as the image display area may be the area on which the operators UI are displayed.

The operator UI1 is an object for instructing the CPU 101 to execute processing to delete an image selected by the image selection screen G2 from the frame F. The operator UI2 is an object for instructing the CPU 101 to enlarge or reduce the image selected by the image selection screen G2. The operator UI3 is an object for instructing the CPU 101 to execute effect processing (edge enhancement, for example) on the image selected by the image selection screen G2. The operator UI4 is an object for instructing the CPU 101 to rotate the image selected by the image selection screen G2.

When causing the image editing screen G4 to display a plurality of operators UI, the CPU 101 causes the image editing screen G4 to display the operators UI in accordance with a predetermined positional relation. The predetermined positional relation is a positional relation preset for the operators UI. In the present embodiment, as illustrated in FIG. 7A, the predetermined positional relation is a positional relation in which the respective operators UI are arranged at different corners of an image frame W, which is a rectangular frame along the end of the image.

The CPU 101 executes editing processing, which is instructed by an operator UI on which a touch operation detected by the touch panel 14 is performed, on an image within the image frame W on which the operator UI is arranged. In that case, when the editing processing on the image selected by the image selection screen G2 causes rotation, movement, enlargement, reduction, or the like (hereinafter, referred to as the movement or the like) of the image, the CPU 101 also moves the operators UI along with at least one of the movement or the like of the image (refer to FIG. 7A).

When the movement or the like of the image is performed, and when the image editing screen G4 contains a position (a second position) of the operator UI determined based on any position at the end of the image after the movement or the like is performed, the CPU 101 displays the operator UI at the position (the second position) concerned. When the movement or the like of the image is performed, and when a position (a third position) of at least one operator UI (the operator UI2, for example) determined based on any position at the end of the image after the movement or the like is performed moves out of the image editing screen G4 (refer to FIG. 7A), the CPU 101 displays the operator UI at a position (a fourth position) that is within the image editing screen G4 and is different from the position (the third position) concerned. This processing enables, even when the operator UI moves out of the image editing screen G4 by the movement of the image, instructing the execution of the various processing by use of the operators UI without moving the image again, thereby improving the convenience of a user who operates the operators UI.

When a plurality of operators UI are moved to the inside of the image editing screen G4, the CPU 101 displays the operators UI within the image editing screen G4 with the predetermined positional relation maintained. In the present embodiment, the CPU 101 displays a virtual object obtained by reducing the image within the image editing screen G4 and displays the operators UI on the corners of the virtual object with the predetermined positional relation maintained within the image editing screen G4. The corners of the virtual object are an example of the fourth position determined based on any position at the end of the area (a second area) that is a part of the image after the movement or the like of the image is performed and is obtained by reducing the image. The second area is an area obtained by reducing the image based on the central point of the shape of the image after the movement or the like is performed. The shape of the image after the movement or the like is performed and the shape of the second area are similar based on the central point of the shape of the image after the movement or the like is performed.

For example, as illustrated in FIG. 8, when the operators UI1 and UI3 are in a non-display state (that is, a state moving out of the image editing screen G4) along with the enlargement of an image 801 displayed on the image display area R within the frame F, the CPU 101 displays a virtual object VO obtained by reducing the image 801 within the image editing screen G4. As illustrated in FIG. 8, the CPU 101 displays a plurality of the operators UI1, UI2, UI3, and UI4 on the corners of the virtual object VO with the predetermined positional relation maintained.

This processing enables, when the operators UI that have moved out of the image editing screen G4 along with the enlargement of the image 801 are moved to the inside of the image editing screen G4, displaying the operators UI within the image editing screen G4 with the same positional relation as the positional relation before the enlargement of the image 801, thereby further improving the convenience of the operators UI.

In the present embodiment, when the operators UI move out of the image editing screen G4, the operators UI are displayed at the end of the virtual object obtained by reducing the image, thereby displaying the operators with the predetermined positional relation maintained. However, that is not limiting so long as the operators UI are displayed with the predetermined positional relation. The operators UI may be, for example, displayed on the end of a rectangular object having the same aspect ratio as the image or corners with the same angle as those of the image, thereby displaying the operators UI with the predetermined positional relation.

The present embodiment describes a method for, when the operators UI move out of the image editing screen G4 by the processing to enlarge the image, moving the operators UI to the inside of the image editing screen G4. Also when the display area of the image moves by the movement or the like of the image, and the operators UI move out of the image editing screen G4, the operators UI are moved to the inside the image editing screen G4 in a similar manner.

Described next is stamp pasting processing when the execution of the stamp pasting processing is instructed by use of the stamp paste button B3. When the execution of the stamp pasting processing is instructed by use of the stamp paste button B3, the CPU 101 causes the display screen 13 to display a stamp selection screen for performing the selection of a stamp to be pasted on a frame and editing processing on the stamp.

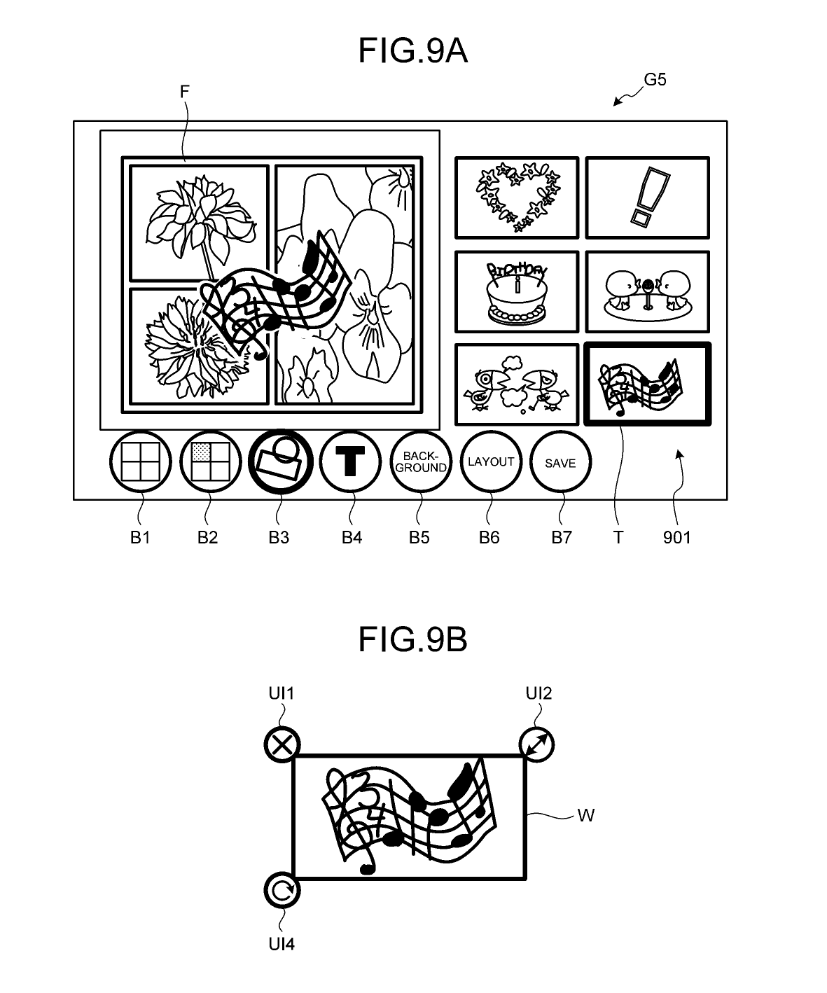

FIGS. 9A and 9B are diagrams illustrating an example of the stamp selection screen displayed by the tablet terminal in the first embodiment. As illustrated in FIG. 9A, the CPU 101 causes the display screen 13 to display a stamp selection screen G5 containing the frame F, the various buttons B, and a list 901 of stamps that can be pasted on the frame F.

In the present embodiment, the CPU 101 pastes a stamp on which a touch operation T detected by the touch panel 14 is performed among the list 901 of stamps displayed on the stamp selection screen G5 on the frame F. As illustrated in FIG. 9B, when the stamp is pasted on the frame F, the CPU 101 arranges the operators UI1, UI2, and UI4 at a position (the first position) determined based on any position of the end of the stamp (an example of a first object) pasted on the frame F for instructing the execution of the editing processing (an example of processing) on the stamp on the stamp selection screen G5.

In that case, as illustrated in FIG. 9B, the CPU 101 displays the operators UI at the different corners of the image frame W which is a rectangular frame along the end of the stamp with the predetermined positional relation in a similar manner to when the operators UI are arranged at the end of the image.

Processing on the stamp instructed by the operators UI displayed on the stamp selection screen G5 and a method for displaying the operators UI on the stamp selection screen G5 are similar to the processing on the image instructed by the operators UI on the image editing screen G4 and the method for displaying the operators UI on the image editing screen G4, respectively.

Described next is text pasting processing when the execution of the text pasting processing is instructed by use of the text paste button B4. When the execution of the text pasting processing is instructed by use of the text paste button B4, the CPU 101 causes the display screen 13 to display a text editing screen for executing the selection of text to be pasted on the frame and editing processing on the text.

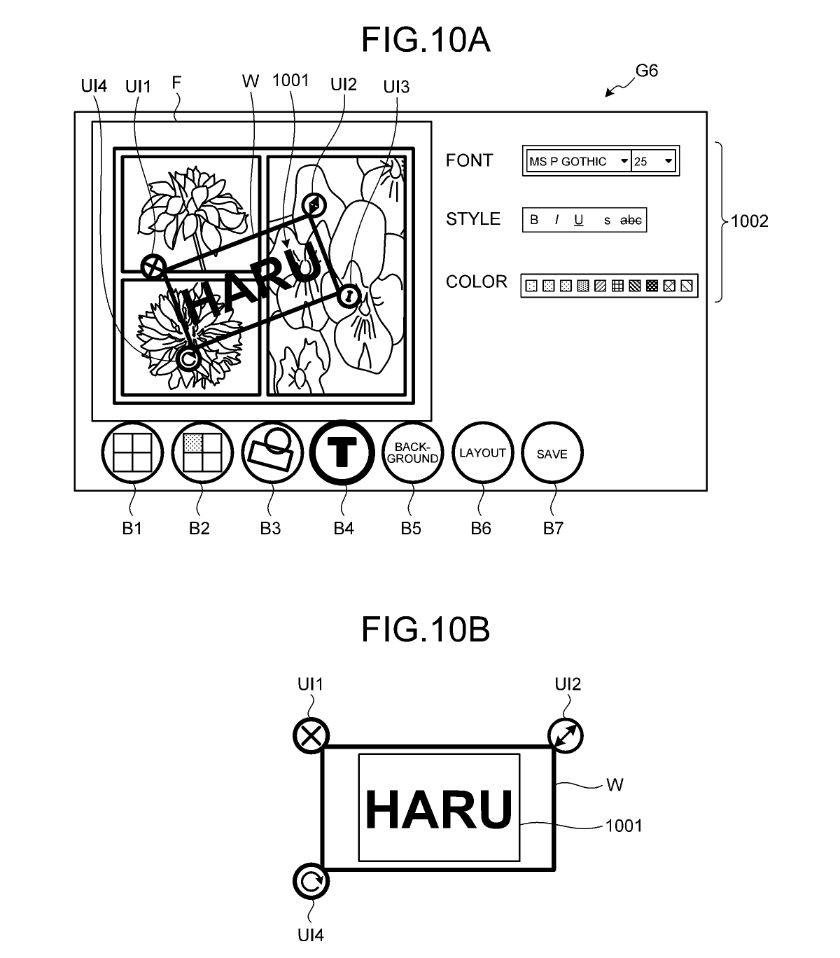

FIGS. 10A and 10B are diagrams illustrating an example of the text editing screen displayed by the tablet terminal in the first embodiment. As illustrated in FIG. 10A, the CPU 101 causes the display screen 13 to display a text editing screen G6 containing the frame F, the various buttons B, a format setting tool 1002 for setting the format (font, size, style such as bold and italic, text color, or text position such as flush left, flush right, and centering, for example) of text 1001 pasted on the frame F.

In the present embodiment, after the text editing screen G6 is displayed on the display screen 13, when a touch operation on the frame F is detected by the touch panel 14, the CPU 101 causes the display screen 13 to display a text input box (not illustrated) for inputting text to be pasted on the frame F. When text is input by use of the text input box, the CPU 101 pastes the input text 1001 (an example of the first object) on the frame F. When the text 1001 is pasted on the frame F, as illustrated in FIG. 10A and FIG. 10B, the CPU 101 arranges the operators UI1, UI2, and UI4 at a position (the first position) determined based on any position of the end of the text 1001 pasted on the frame F for instructing the execution of the editing processing (an example of the processing) on the text 1001 on the text editing screen G6.

In that case, as illustrated in FIG. 10A and FIG. 10B, the CPU 101 displays the operators UI at the different corners of the image frame W as a rectangular frame along the end of the text 1001 with the predetermined positional relation in a similar manner to when the operators UI are arranged at the end of the image.

Processing on the text 1001 instructed by the operators UI displayed on the text editing screen G6 and a method for displaying the operators UI on the text editing screen G6 are similar to the processing on the image instructed by the operators UI on the image editing screen G4 and the method for displaying the operators UI on the image editing screen G4, respectively.

Described next is processing to select a background image when the selection of the background image is instructed by use of the background selection button B5. When the execution of the processing to select the background image of the images arranged in the frame is instructed by use of the background selection button B5, the CPU 101 causes the display screen 13 to display a background selection screen for selecting the background image of the images arranged in the frame.

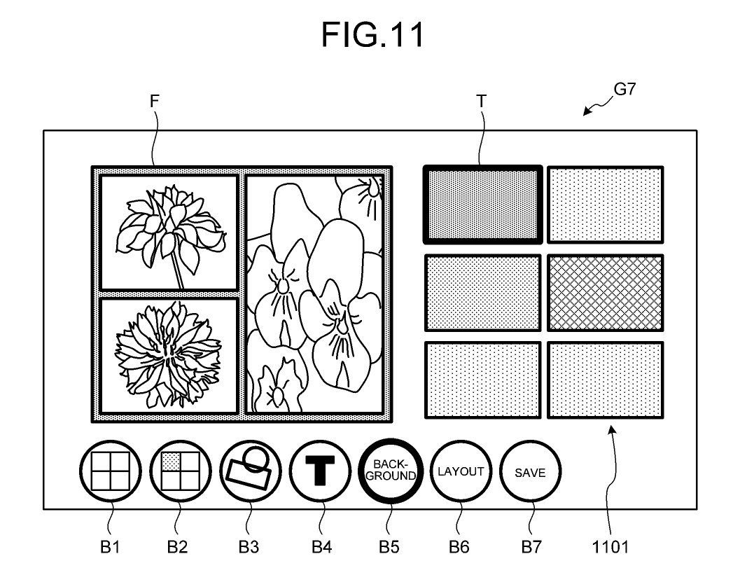

FIG. 11 is a diagram illustrating an example of the background selection screen displayed by the tablet terminal in the first embodiment. As illustrated in FIG. 11, the CPU 101 causes the display screen 13 to display a background selection screen G7 containing the frame F, the various buttons B, and a list 1101 of background images that can be selected as the background image of the images arranged in the frame F. In the present embodiment, the CPU 101 sets a background image on which a touch operation T detected by the touch panel 14 is performed among the list 1101 of background images displayed on the background selection screen G7 as the background image of the images arranged in the frame F.

Described next is layout change processing when a change of the layout of frames (variable frames) is instructed by use of the layout change instruction button B6. When the change of the layout of the frames is instructed by use of the layout change instruction button B6, the CPU 101 causes the display screen 13 to display a layout change screen for changing the layout of the frames.

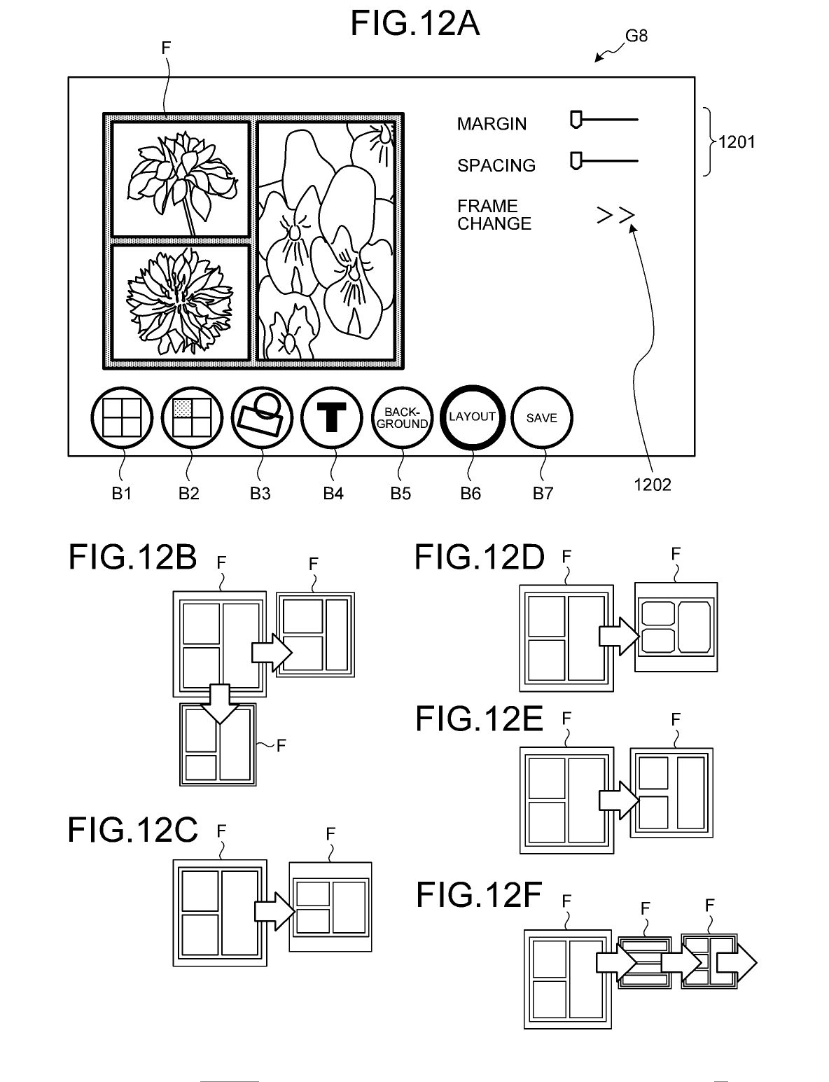

FIGS. 12A to 12F are diagrams illustrating an example of the layout change screen displayed by the tablet terminal in the first embodiment. As illustrated in FIG. 12A, the CPU 101 causes the display screen 13 to display a layout change screen G8 containing the frame F, the various buttons B, a layout change tool 1201 for instructing the CPU 101 to change the layout (a margin within the frame F or the spacing among a plurality of images arranged within the frame F, for example) of the frame F, and a frame change button 1202 for instructing the CPU 101 to change the frame F.

In the present embodiment, as illustrated in FIG. 12A, when a touch operation T on the end of an image is detected by the touch panel 14, and when the touch operation T moves without being released, the CPU 101 changes the size of the frame F as illustrated in FIG. 12B. When a change of the margin within the frame F is instructed by the layout change tool 1201, the CPU 101 changes the margin within the frame F as illustrated in FIG. 12C. When rounding of the corners of the image display areas within the frame F is instructed by use of a round tool (not illustrated), the CPU 101 executes processing to round the corners of the image display areas within the frame F as illustrated in FIG. 12D. When a change of the spacing among the image display areas within the frame F is instructed by the layout change tool 1201, the CPU 101 changes the spacing among the image display areas within the frame F as illustrated in FIG. 12E.

In addition, as illustrated in FIG. 12F, each time a change of the frame F is instructed by use of the frame change button 1202, the CPU 101 changes the frame F arranging the images into another frame in accordance with a preset order. In that case, when the number of the image display areas within the changed frame F is larger than the number of the images selected by use of the image selection screen G2 illustrated in FIG. 5A and 5B, the CPU 101 blanks an image display area in which no image is arranged among the image display areas within the frame F.

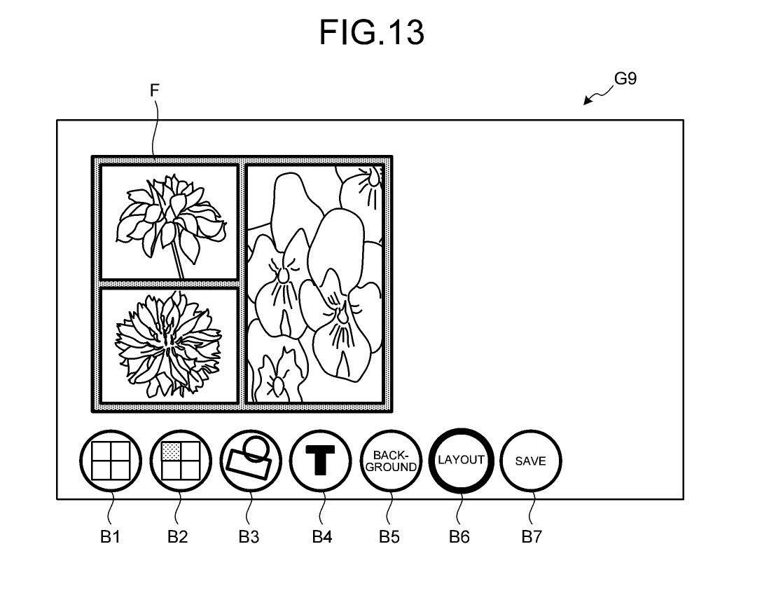

Described next is frame saving processing when the saving of a frame in the nonvolatile memory 106 is instructed by use of the save button B7. FIG. 13 is a diagram illustrating an example of a saving screen displayed by the tablet terminal in the first embodiment. As illustrated in FIG. 13, when the saving of the frame is instructed by use of the save button B7, the CPU 101 saves the image data of the frame F that arranges the images in a storage device such as the nonvolatile memory 106. As illustrated in FIG. 13, the CPU 101 causes the display screen 13 to display a saving screen G9 that arranges the frame F whose image data is saved until the saving of the image data of the frame F in the nonvolatile memory 106 or the like is completed.

Thus, the tablet terminal 1 according to the first embodiment can instruct the execution of the various processing by use of the operators UI, even when the operators UI move out of the display area by the movement of the object such as an image, a stamp, and text, without moving the object again, thereby improving the convenience of the user who operates the operators UI.

### Second Embodiment

A second embodiment is an example in which an operator is arranged at a position separate from the end of an object toward the outside of the object by a given distance. The following describes a part different from the first embodiment.

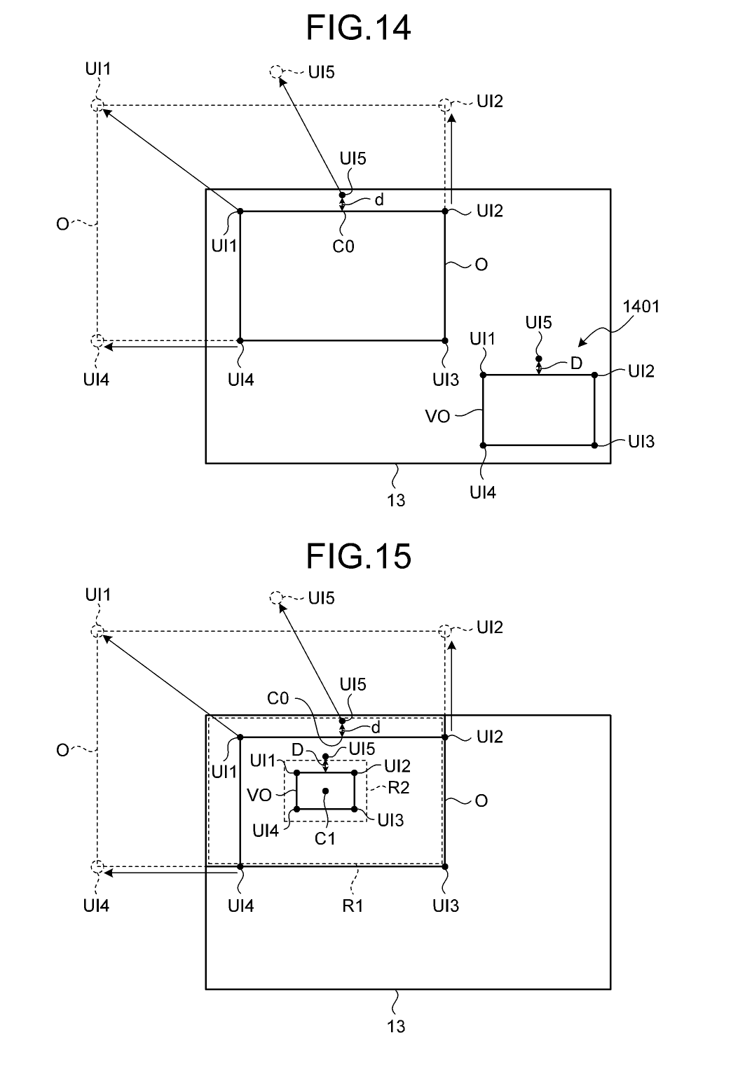

FIG. 14 to FIG. 18 are diagrams for explaining examples of a method for displaying operators by a tablet terminal according to the second embodiment. In the present embodiment, as illustrated in FIG. 14, the CPU 101 causes the display screen 13 to display a rectangular object O (an example of the first object) such as an image, a stamp, and text. In addition, as illustrated in FIG. 14, the CPU 101 displays, in addition to the operators UI1, UI2, UI3, and UI4 arranged at the corners (an example of the end) of the object O displayed on the display screen 13, an operator UI5 at a position separate from the center CO (an example of the end) of the upper side of the object O toward the outside of the object O by a given distance d.

In the present embodiment, when the enlargement or the like of the object O is instructed by use of the operators UI displayed on the display screen 13, as illustrated in FIG. 14, the CPU 101 executes enlargement processing or the like on the object O. When any of the enlargement or the like of the object O is performed, and when the display area of the display screen 13 contains a position (the second position) determined based on any position of the end of the object O after any of the enlargement or the like of the Object O is performed, the CPU 101 displays the operators UI at the second position. When any of the enlargement or the like of the object O is performed, and when the display area of the display screen 13 does not contain a position (the third position) determined based on any position at the end of the object O after any of the enlargement or the like of the Object O is performed, as illustrated in FIG. 14, the CPU 101 moves the operators UI to a non-display area 1401 (an example of a position that is within the display area of the display screen 13 and is different from the third position) in which the object O is not displayed on the display screen 13. This processing enables, even when the operators UI move out of the display screen 13 by the movement of the image, instructing the CPU 101 to execute the various processing by use of the operators UI without moving the object again, thereby improving the convenience of the user who operates the operators UI.

In that case, the CPU 101 displays the operators UI within the display screen 13 with a predetermined positional relation. Specifically, as illustrated in FIG. 14, the CPU 101 displays the operators UI at the corners of the virtual object VO and a position separate from the center of the upper side of the virtual object VO toward the outside of the virtual object VO by a given distance D. In this example, the virtual object VO is an object obtained by reducing the object O, a rectangular frame along the end of the object O, or the like. This processing enables, when the operators UI that have moved out of the display screen 13 along with the movement of object O are moved to the inside of the display screen 13, displaying the operators UI within the display screen 13 with the same positional relation as the positional relation before the movement of the object O, thereby further improving the convenience of the operators UI.

As illustrated in FIG. 15, when the operators UI1, UI2, UI4, and UI5 move out of the display screen 13 by the enlargement processing or the like on the object O, the CPU 101 may display the operators UI1, UI2, UI3, UI4, and UI5 within a given range R2 based on the center C1 of a display area R1 positioned within the display screen 13 in the object O on which the enlargement processing or the like is performed. Although the CPU 101 displays the operators UI at the positions determined based on the center C1 of the display area R1 in this example, that is not limiting so long as the operators UI are displayed at a position determined based on any position of the end of an area that is part of the object O after any of the enlargement processing or the like is performed and is contained in the display screen 13.

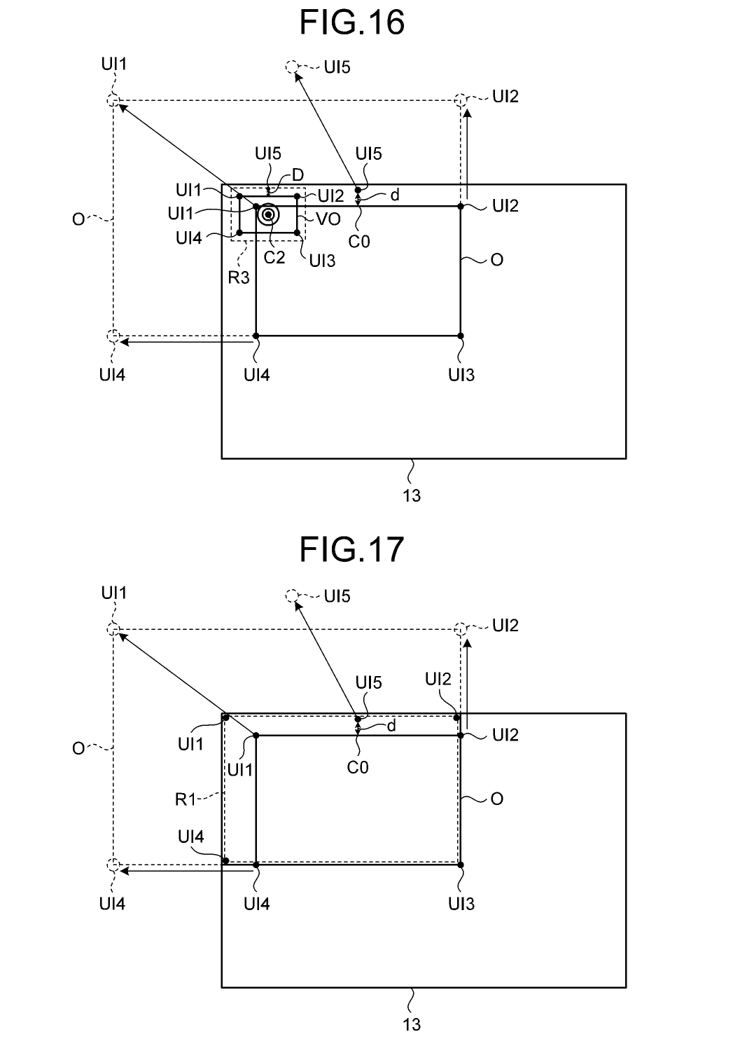

For example, as illustrated in FIG. 16, when the operators UI1, UI2, UI4, and UI5 move out of the display screen 13 by the enlargement processing or the like on the object O, the CPU 101 may display the operators UI1, UI2, UI3, UI4, and UI5 within a given range R3 based on the center C2 of the object O on which the enlargement processing or the like is performed. This processing enables displaying the operators UI deviated in the moving direction of the object O, thereby easily determining in which direction the object O is moved.

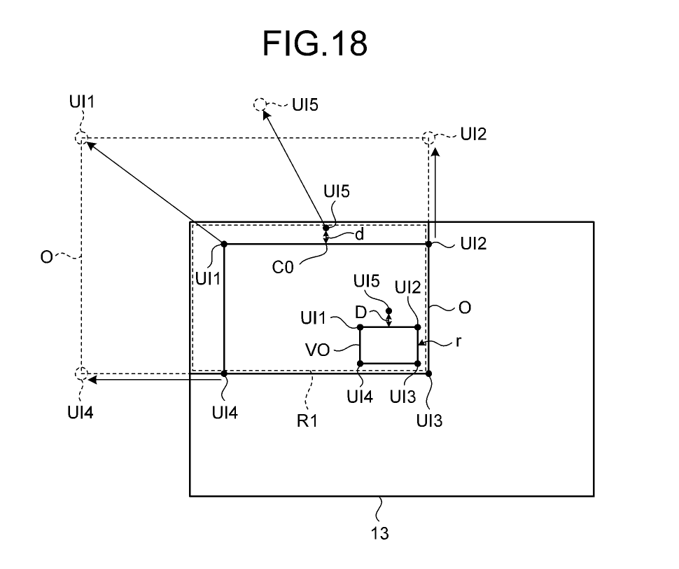

As illustrated in FIG. 17, when the operators UI1, UI2, UI4, and UI5 move out of the display screen 13 by the enlargement processing or the like on the object O, the CPU 101 displays the operators UI at the corners (an example of the end) of the display area R1 within the display screen 13 in the object O. Alternatively, as illustrated in FIG. 18, when the operators UI1, UI2, UI4, and UI5 move out of the display screen 13 by the enlargement processing or the like on the object O, the CPU 101 displays the operators UI in a partial area r (a rectangular partial area near the corner of the display area R1, for example) as part of the display area R1.

Thus, the tablet terminal 1 according to the second embodiment can achieve a similar effect to that of the first embodiment even when the operator UI is arranged at a position separate from the end of the object O toward the outside of the object O by a given distance.

As described above, the first and second embodiments can improve the convenience of the user who operates the operators UI.

Although a computer program executed by the tablet terminal 1 according to the embodiments is embedded and provided in the nonvolatile memory 106 such as a ROM, that is not limiting, and it may be, for example, recorded and provided in a computer-readable recording medium such as a CD-ROM, a flexible disk (FD), a CD-R, and a digital versatile disc (DVD) as an installable or executable file.

The computer program executed by the tablet terminal 1 according to the embodiments may be stored in a computer connected to a network such as the Internet and provided by being downloaded via the network. Furthermore, the computer program executed by the tablet terminal 1 according to the embodiments maybe provided or distributed via a network such as the Internet.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
circuitry configured to:
cause a first object and a first operator to be displayed on a display area of a display,
the first operator used for issuing an instruction to execute a process comprising at least one of a movement, an enlargement, or a reduction of the first object, the first operator positioned at a first position determined according to an edge position of the first object,
display the first operator at a second position when the second position of the first operator determined according to an edge position of the first object is inside of the display area after at least one of a movement, an enlargement, or a reduction of the first object,
display the first operator at a fourth position different from a third position when the third position of the first operator determined according to a third edge position of the first object is outside of the display area after at least one of a movement, an enlargement, or a reduction of the first object.

2. The electronic device of claim 1, wherein the fourth position is based on a fourth one of a plurality of positions at an edge position of a first area that is a part of the first object after the movement, the enlargement, and/or the reduction of the first object and in the display area.

3. The electronic device of claim 1, wherein the fourth position is based on the fourth one of a plurality of positions at an edge position of a second area that is a part of the first object after the movement, the enlargement, or the reduction of the first object and obtained by reducing the first object.

4. The electronic device of claim 3, wherein
the second area is obtained by reducing the first object based on the central point of the shape of the first object after the movement, the enlargement, or the reduction of the first object,
the shape of the first object after the movement, the enlargement, or the reduction of the first object and the shape of the second area are similar based on the central point of the shape of the first object after the movement, the enlargement, or the reduction of the first object.

5. The electronic device of claim 1, wherein the fourth position is an edge position of a fourth area in the display area in the first object after the movement, the enlargement, or the reduction of the first object or a partial area within the display area in the first object.

6. A displaying method comprising:
causing a first object and a first operator to be displayed on a display area of a display,
the first operator used for issuing an instruction to execute a process comprising at least one of a movement, an enlargement, or a reduction of the first object, the first operator positioned at a first position determined according to an edge position of the first object,
further displaying the first operator at a second position when the second position of the first operator determined according to an edge position of the first object is inside of the display area at least one of a movement, an enlargement, or a reduction of the first object,
further displaying the first operator at a fourth position different from a third position when the third position of the first operator determined according to third edge position of the first object is outside of the display area after at least one of a movement, an enlargement, or a reduction of the first object.

7. The displaying method of claim 6, wherein the fourth position is determined based on a fourth one of positions at an edge position of a first area that is a part of the first object after movement, enlargement, or reduction of the first object is performed and is contained in the display area.

8. The displaying method of claim 6, wherein the fourth position is determined based on the fourth one of positions at an edge position of a second area that is apart of the first object after movement, enlargement, or reduction of the first object is performed and is obtained by reducing the first object.

9. The displaying method of claim 8, wherein
the second area is obtained by reducing the first object based on the central point of the shape of the first object after the movement, enlargement, or reduction of the first object is performed,
the shape of the first object after movement, enlargement, or reduction of the first object is performed and the shape of the second area are similar based on the central point of the shape of the first object after movement, enlargement, or reduction of the first object is performed.

10. The displaying method of claim 6, wherein the fourth position is an edge position of a fourth area contained in the display area in the first object after movement, enlargement, or reduction of the first object is performed or a partial area within the display area in the first object.

11. A computer program product having a non-transitory computer readable medium including programmed instructions wherein the instructions, when executed by a computer, cause the computer to perform:
causing a first object and a first operator to be displayed on a display area of a display,
the first operator used for issuing an instruction to execute a process comprising at least one of a movement, an enlargement, or a reduction of the first object, the first operator positioned at a first position determined according to an edge position of the first object,
displaying the first operator at a second position when the second position of the first operator determined according to and an edge position of the first object is inside of the display area at least one of a movement, an enlargement, or a reduction of the first object,
displaying the first operator at a fourth position different from a third position when the third position of the first operator determined according to third edge position of the first object is outside of the display area after at least one of a movement, an enlargement, or a reduction of the first object.

12. The computer program product of claim 11, wherein the fourth position is determined based on a fourth one of positions at an edge position of a first area that is a part of the first object after movement, enlargement, or reduction of the first object is performed and is contained in the display area.

13. The computer program product of claim 11, wherein the fourth position is determined based on the fourth one of positions at an edge position of a second area that is a part of the first object after movement, enlargement, or reduction of the first object is performed and is obtained by reducing the first object.

14. The computer program product of claim 13, wherein
the second area is obtained by reducing the first object based on the central point of the shape of the first object after movement, enlargement, or reduction of the first object is performed,
the shape of the first object after movement, enlargement, or reduction of the first object is performed and the shape of the second area are similar based on the central point of the shape of the first object after movement, enlargement, or reduction of the first object is performed.

15. The computer program product of claim 11, wherein the fourth position is an edge position of a fourth area contained in the display area in the first object after movement, enlargement, or reduction of the first object is performed or a partial area within the display area in the first object.
